(19) United States
(12) Patent Application Publication
(10) Pub. No.: US 2008/0101325 A1
(43) Pub. Date: May 1, 2008

(54) Wireless relay device deployment methods and apparatus

(76) Inventors: Qi Bao, Westborough, MA (US); Whay Chiou Lee, Cambridge, MA (US)

Correspondence Address: INGRASSIA FISHER & LORENZ, P.C., 7150 E. CAMELBACK, STE. 325, SCOTTSDALE, AZ, 85251, US

(21) Appl. No.: 11/590,359

(22) Filed: Oct. 31, 2006

(51) Int. Cl. H04J 3/00

(52) U.S. Cl. 370/345

(57) ABSTRACT

In an embodiment, an adaptively-augmentable wireless network (100, FIG. 1) may include at least one mobile device (110-115) and at least one relay device (104-109). During network setup, a mobile device associated with a first host user may determine (505, FIG. 5) that no relay device signal is receivable by the mobile device which has an adequate signal quality. When an undeployed relay device is not available to the first host user, he mobile device may transmit (508) a deployment request message (700, FIG. 7). Another mobile device associated with a second host user may receive (902, FIG. 9) the deployment request message, and may determine (908) whether to initiate deployment of an undeployed relay device associated with the second host user. When the other mobile device decides to initiate deployment, it may transmit (912) a responsive deployment announcement message (800, FIG. 8). Accordingly, collaborative relay device deployment is achievable.

### TECHNICAL FIELD

Embodiments of the inventive subject matter relate generally to wireless communication networks, and more specifically to deployment of wireless relay devices within adaptively-augmentable wireless communication networks.

### BACKGROUND

The ability to rapidly set up a temporary wireless communication network may be very desirable, in certain situations. For example, at an incident scene, an agency may want to set up a wireless communication network to assist host users (e.g., firefighters, police officers, security personnel, military personnel, and/or medical personnel) in communicating with each other and/or with a command center (also known as a control center). Incident scenes may include, for example, event locations, urban or rural fires, natural disaster areas, rescue areas, and police or military deployment areas, to name a few.

Establishment of a temporary wireless communication network may be assisted, at least in part, by one or more host users. A host user may be, for example, a person who may travel on foot or in a vehicle, while carrying with him various apparatus associated with the network. For example, a host user may carry a radio, which is capable of communicating with other radios, a command center, and relay devices interposed between the host user and the command center. In addition, a host user may carry one or more relay devices, which the host user may deploy at various locations. For example, when a host user's radio detects that it is moving into a marginal signal area (e.g., an area nearly out of radio range of a command center or a previously-deployed relay device), the radio may alert the host user, and the host user may deploy a relay device at his current location. A wireless communication network deployed in this manner may be referred to as an “ad-hoc” or “adaptively-augmentable” network.

Each relay device may take a certain period of time to deploy (“deployment time”). This deployment time may include the time for the host user to react to an alert from his radio and to enable a relay device. Deployment time also may include the time for the relay device to establish itself with the network, and for in-range radios to recognize the newly-established relay device. Once deployment is completed, the newly-established relay device may provide communication service within the area.

During the deployment time of a relay device, a possibility may exist that at least one other, nearby host user also may deploy one of his relay devices to provide service substantially within the same coverage area. Multiple relay devices deployed substantially within the same coverage area may be referred to as “redundant relay devices.” Deployment of redundant relay devices may be undesirable for at least two reasons.

One reason that deployment of redundant relay devices may be undesirable is that such deployment may reduce the possible cumulative coverage area of an adaptively-augmentable network. The cumulative coverage area of an adaptively-augmentable network includes the geographic area within which the command center and the deployed relay devices may provide communication service to radios. Assuming that a fixed number of relay devices are available, the number of redundant relay devices may affect the size of the cumulative coverage area. As the number of redundant relay devices increases, the possible cumulative coverage area may be decreased significantly. When very few or no redundant relay devices are deployed, the possible cumulative coverage area maybe closer to optimal.

Another reason that deployment of redundant relay devices may be undesirable is that a host user who deploys a redundant relay device is more likely prematurely to run out of relay devices, thus limiting his safe range of operations. At an incident scene, a host user's ability to communicate with a control center or deployed relay device may be important to his safety and/or the safety of victims whom the host user may be attempting to help. A host user who has no more relay devices available to deploy may be unable to extend his communication range. Accordingly, in order to increase his safe range of operations, a host user may benefit from reducing a likelihood of deploying redundant relay devices.

During system operation, a radio may communicate with one or more neighboring devices (e.g., other radios, control centers or deployed relay devices). When a radio determines that all of the signals from its neighboring devices have fallen below a threshold, the radio may alert the user that relay device deployment should occur. Under some conditions, current methods may allow the radio to become isolated from the system (e.g., to lose connectivity). Isolation may occur, for example, when a first radio initially has a second radio and a relay device as neighboring devices. If the first radio moves out of range of the relay device, but still is within range of the second radio, the first radio may not alert the host user to deploy a relay device. If the first radio then moves out of range of the second radio, then the first radio may alert the host user to deploy a relay device. However, at that time, both the first radio and the relay device may be out of range of any previously-deployed relay device or any other radio. Accordingly, the first radio may be incapable of connecting with the network, and thus may be isolated from the network.

Current processes used for deployment of relay devices may detrimentally affect the size of the possible cumulative coverage area of an adaptively-augmentable network, and/or may reduce a host user's potential range of safe operations. In addition, current processes may result in isolated radios. For at least these reasons, what are needed are methods of deploying relay devices within an adaptively-augmentable network, which may reduce the likelihood of redundant relay device deployment, and/or which may decrease the likelihood of radios becoming isolated from the network. Also needed are apparatus within which these methods may be carried out.

### BRIEF DESCRIPTION OF THE DRAWINGS

FIG. 1 illustrates a conceptual diagram of an adaptively-augmentable wireless communication system, in accordance with an example embodiment;

FIG. 2 illustrates a simplified block diagram of a mobile device, in accordance with an example embodiment;

FIG. 3 illustrates a conceptual diagram of an adaptively-augmentable wireless communication system, in accordance with another example embodiment;

FIG. 4 illustrates a conceptual diagram of signal quality threshold perimeters, in accordance with an example embodiment;

FIG. 5 illustrates a flowchart of a method for recognizing and responding to a deployment event, in accordance with an example embodiment;

FIG. 6 illustrates a field device neighbor table, in accordance with an example embodiment;

FIG. 7 illustrates a deployment request message format, in accordance with an example embodiment;

FIG. 8 illustrates a deployment announcement message format, in accordance with an example embodiment;

FIG. 9 illustrates a flowchart of a method for receiving and responding to a deployment request message, in accordance with an example embodiment;

FIG. 10 illustrates a flowchart of a method for making a deployment decision, in accordance with an example embodiment; and

FIG. 11 illustrates a backoff period table, in accordance with an example embodiment.

### DETAILED DESCRIPTION

The following detailed description of the inventive subject matter is merely exemplary in nature and is not intended to limit the inventive subject matter or the application and uses of the inventive subject matter. Furthermore, there is no intention to be bound by any theory presented in the preceding background or the following detailed description.

Embodiments described herein include methods and apparatus for deploying wireless relay devices within an adaptively-augmentable wireless communication system or wireless network. As used herein, the term “host user” may mean a male or female person animal or a robotic device, which may carry with him a mobile device and at least one relay device, and which may be capable of detecting and responding to an alert from the mobile device. For purposes of convenience only, male pronouns (e.g., “he” and “his”) are used in this description to indicate a host user.

As will be described in detail below, a finite set of relay devices may be available to deploy within an adaptively-augmentable wireless communication network. Embodiments of the inventive subject matter may provide for “collaborative deployment” of the finite set of relay devices, through the exchange, between mobile devices, of messages included within a set of collaborative deployment messages. As used herein, the term “collaborative deployment” may mean the deployment of relay devices by multiple host users in response to messages exchanged between mobile devices, where the messages include deployment requests and deployment announcements. The term “collaborative deployment” also may mean probabilistic deferment of relay device deployment to statistically control an expected total number of relay devices deployed by multiple host users in response to a deployment request, in an embodiment.

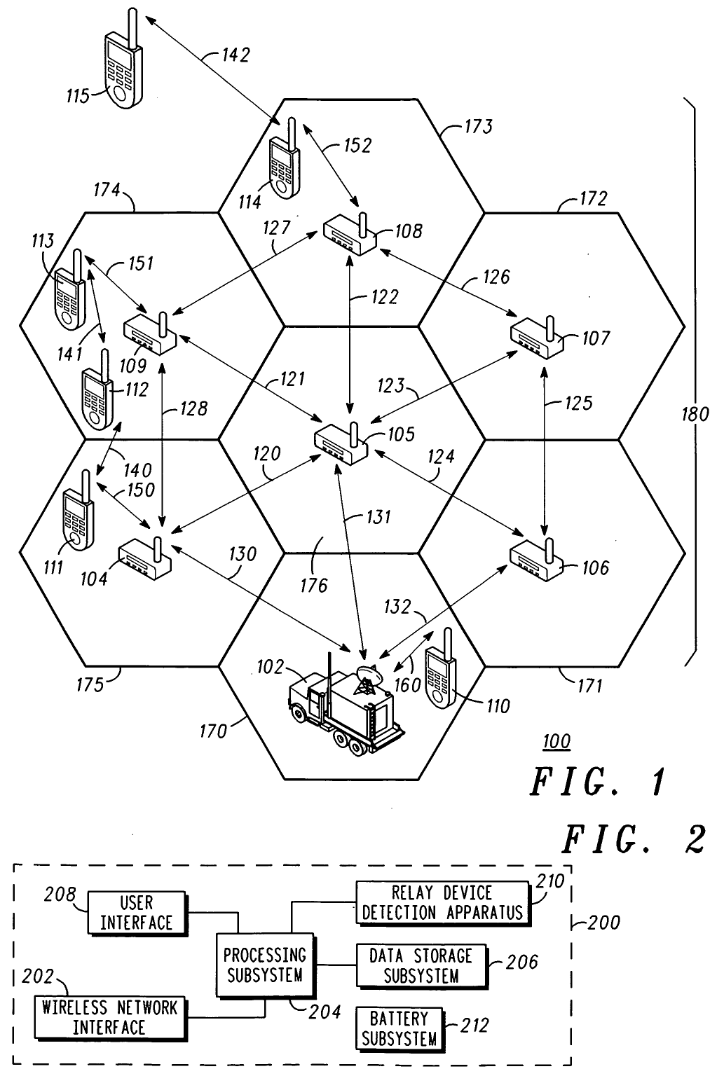

FIG. 1 illustrates a conceptual diagram of an adaptively-augmentable wireless communication system 100, in accordance with an example embodiment. System 100 includes a control center 102, multiple deployed relay devices 104, 105, 106, 107, 108, 109, and multiple mobile devices 110, 111, 112, 113, 114, 115. Control center 102, deployed relay devices (e.g., relay devices 104-109) and mobile devices (e.g., devices 110-115) may be referred to collectively as “field devices,” herein. Although one control center 102, six relay devices 104-109, and seven mobile devices 110-115 are illustrated, system 100 may include more than one control center, more or fewer relay devices, and/or more or fewer mobile devices. As will be evident later, hexagonal coverage areas 170-176 are modeled as such only for illustrative purposes. In other embodiments, coverage areas may have other geometric or irregular shapes.

In an embodiment, system 100 may form a portion of an “ad-hoc” or “adaptively-augmentable” network. In various embodiments, the term “adaptively-augmentable network” may mean a wireless communication network formed from at least one control center and a variable number of relay devices, which may be dynamically added to the network, as needed, to provide network connectivity to one or more mobile devices. Specifically, in various embodiments, the number of relay devices included in the network may change over time. For example, at a first time, system 100 may include zero relay devices, and mobile devices (e.g., device 110) may communicate directly with a control center (e.g., control center 102). At a second time, which may be later than the first time, system 100 may include multiple deployed relay devices (e.g., devices 104-109), and mobile devices (e.g., devices 110-115) may communicate with the control center or other devices via the multiple deployed relay devices.

In an embodiment, during system operation, a host user (not illustrated) may communicate with an adaptively-augmentable network through at least one mobile device (e.g., one of mobile devices 110-115). In addition, a host user may carry with him at least one undeployed relay device, which he may deploy in order to establish the adaptively-augmentable network. Accordingly, a mobile device and an undeployed relay device may be “associated with” a particular host user. In a typical scenario, when network setup is initiated, a host user may carry one mobile device (e.g., one of mobile devices 110-115) and multiple relay devices (e.g., selected ones of relay devices 104-109, prior to deployment). Each relay device may be connected to a carrying apparatus (e.g., a harness or backpack, not illustrated), prior to the relay device's deployment A “deployed” relay device (e.g., relay devices 104-109) may include a relay device that has been powered up and has established communications with the network. An “undeployed relay device” may include a relay device that has not established communications with the network (e.g., a relay device that is powered-down and/or still connected to a host user's carrying apparatus).

In an embodiment, a relay device 104-109 may be an apparatus, which enables communication between control center 102 and other field devices (e.g., relay devices 104-109 and/or mobile devices 110-115), once it is deployed. Selected ones of deployed relay devices 104-109 may communicate with each other over relay-to-relay radio links 120, 121, 122, 123, 124, 125, 126, 127, 128, in an embodiment. In addition, in an embodiment, control center 102 may communicate with deployed relay devices 104-109 over control-to-relay links 130, 131, 132. Communication, as described above, may be over one hop or multiple hops, where a “hop” refers to a direct radio link without any intermediate field device or control center.

In an embodiment, a relay device 104-109 may include various apparatus (not illustrated), including but not limited to, at least one wireless network interface, at least one processing subsystem, at least one data storage subsystem, at least one user interface, and a battery subsystem. A deployed relay device 104-109 may receive and relay information, in the form of analog radio signals, over wireless links (e.g., links 120-128, 130-132) via the at least one wireless network interface. A wireless network interface may provide an interface between the relay device and the air interface. Received information may be processed using a processing subsystem, and data may be stored to and/or retrieved from a data storage subsystem during the processing. A user interface may include indicators for conveying network connectivity and device power, among other things. Further, a user interface may include one or more speakers or mechanical devices to provide audible and or vibratory alerts to assist in relay device deployment or retrieval, for example. In an embodiment, device power is provided by one or more batteries installed in a battery subsystem.

Control center 102 may be a portable or stationary apparatus, which includes apparatus for enabling communication between the control center 102 and field devices (e.g., relay devices 104-109 and/or mobile devices 110-115). Control center 102 may be located in a centralized location or may be distributed. Further, in various embodiments, all or portions of control center may be located on a vehicle, within a structure, or out in the open air. Control center 102 may be useful, for example, as a base of operations when providing a response at an incident scene or in coordinating event activities. In an embodiment, once control center 102 is established, it may remain substantially stationary.

In an embodiment, control center 102 may include various apparatus (not illustrated), including but not limited to, at least one wireless network interface, at least one processing subsystem, at least one data storage subsystem, and at least one user interface. Control center 102 may receive information, in the form of analog radio signals, over wireless links (e.g., links 130-132, 160) via the at least one wireless network interface (e.g., an interface between the control center and the air interface). Control center 102 may process that information using the at least one processing subsystem. Data may be stored to or retrieved from a data storage subsystem during the processing. The processed information may be conveyed to an attendant thorough one or more user interfaces (e.g., speakers, headsets, monitors, indicator lights). The attendant may provide commands or other information through one or more additional user interfaces (e.g., microphones, keyboards, pointing devices, touchscreens) The information may be processed by the at least one processing subsystem, and transmitted over the air by the at least one wireless network interface. Information may be transmitted in the form of analog radio signals.

Mobile devices 110-115 may include, for example, one-way and two-way radios, personal data assistants (PDA), pagers, wireless phones, and/or other wireless communication devices. Selected ones of mobile devices 110-115 may communicate with each other over mobile-to-mobile radio links 140, 141, 142. In addition, in an embodiment, selected ones of mobile devices 110-115 and selected ones of deployed relay devices 104-109 may communicate with each other over mobile-to-relay radio links 150, 151, 152. In addition, in an embodiment, selected ones of mobile devices 110 and control center 102 may communicate with each other over mobile-to-control radio links 160.

FIG. 2 illustrates a simplified block diagram of a mobile device 200, in accordance with an example embodiment. In an embodiment, mobile device 2CD may include at least one wireless network interface 202, at least one processing subsystem 204, at least one data storage subsystem 206, at least one user interface 208, at least one relay device detection apparatus 210, and at least one battery subsystem 212. Wireless network interface 202 may be configured to receive and/or transmit messages over an air interface. Accordingly, mobile device 200 may receive information over wireless links (e.g., links 140-142, 150-152, 160, FIG. 1) via the at least one wireless network interface 202. In an embodiment, the at least one wireless network interface 202 may include at least one antenna and other apparatus for receiving analog signals from the air interface, and for converting the analog signals into digital data for processing by the at least one processing subsystem 204. Wireless network interface 202 additionally may convert digital data received from a processing subsystem 204 into analog signals for transmission over the air interface by the at least ore antenna.

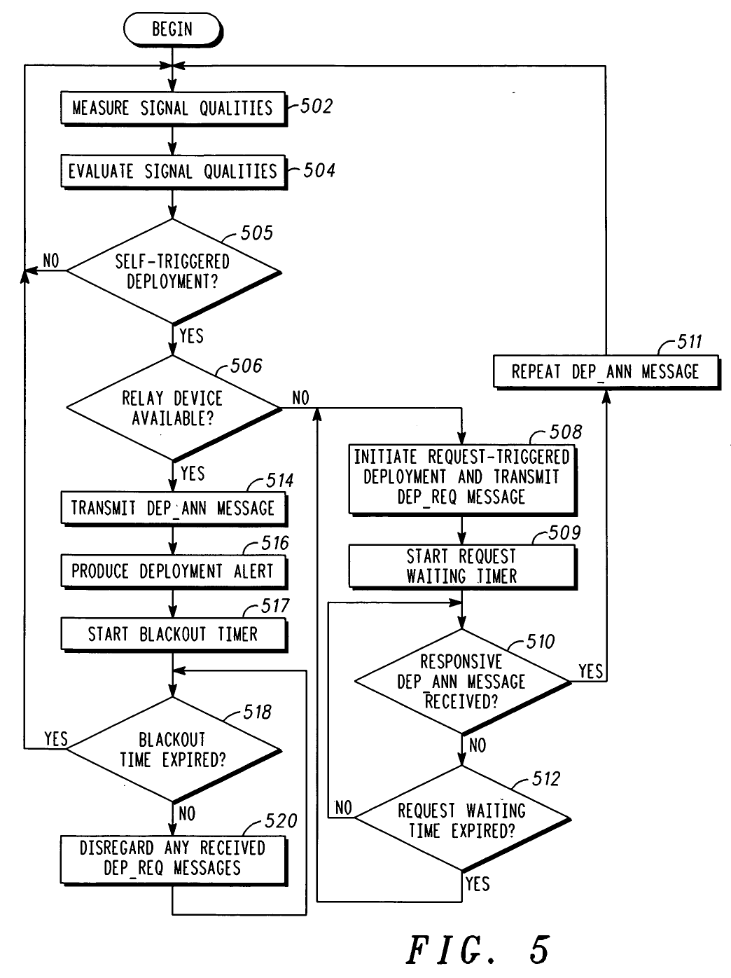

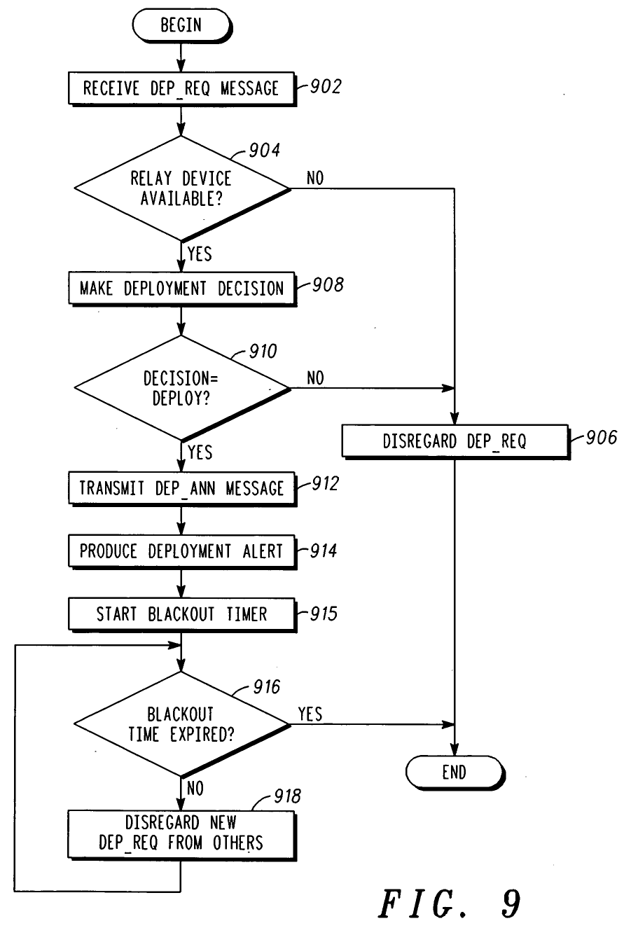

As will be described in more detail later, the at least one processing subsystem 204 may be configured to make a deployment decision to initiate the deployment of an undeployed relay device, among other things. The at least one processing subsystem 204 may be operatively coupled to the wireless network interface 202, in an embodiment, and accordingly may receive digital data from and provide digital data to wireless network interface 202. The digital data may include, for example, one or more messages received from or destined for other field devices (e.g., 104-115, FIG. 1) and/or a control center (e.g., control center 102). Embodiments of various messages that may be processed by or produced by the at least one processing subsystem 204 will be described in conjunction with FIGS. 7 and 8, later. Additionally, embodiments of various processes that may be performed by the at least one processing subsystem 204 will be described in detail in conjunction with FIGS. 5, 9, and 10, later.

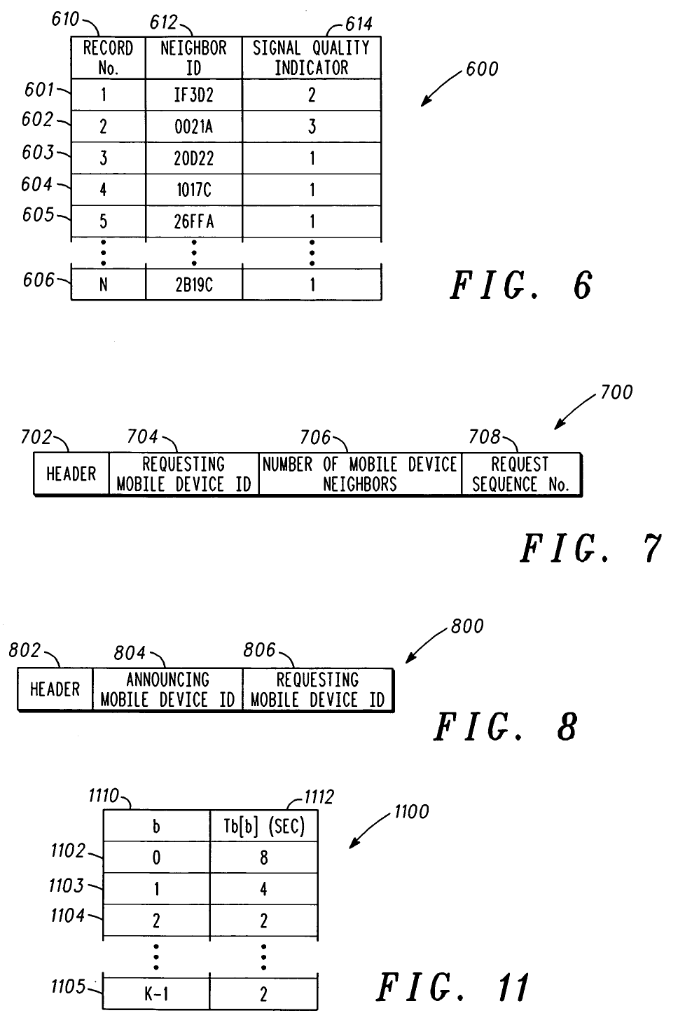

Processing subsystem 204 may store data to and/or retrieve data from the at least one data storage subsystem 206. Data storage subsystem 206 may include, for example, one or more volatile or non-volatile storage components, such as random access memory (RAM), read only memory (ROM), numerous variations of those types of memories, and/or other types of storage. In an embodiment, the at least one data storage subsystem 206 may be used to maintain a neighboring device table (e.g., table 600, FIG. 6) and to store a deployment backoff period table (e.g., table 1100, FIG. 11), as will be described in more detail later.

The at least one user interface 208 may include various apparatus (not illustrated), including, for example, at least one speaker, microphone, keypad, keyboard, display, camera, mechanical vibration device, and light indicator, among other things. In an embodiment, among other things, the at least one user interface 208 receives input audio information from the host user (e.g., via a microphone), and converts the audio information into digital data that may be processed by the at least one processing subsystem 204. In addition, the at least one user interface 208 may receive digital data from the at least one processing subsystem 204, and output audio information (e.g., via a speaker). The at least one user interface 208 may receive and output other types of information, as well.

In an embodiment, the at least one relay device detection apparatus 210 may be configured to detect the presence of undeployed relay devices in proximity to the mobile device 200. The at least one relay device detection apparatus 210 may be operatively coupled to the at least one processing subsystem 204, in an embodiment. Either or both an undeployed relay device and/or a carrying apparatus (e.g., a harness or backpack to which an undeployed relay device is connected, not illustrated) may provide information, which may be received by the at least one relay device detection apparatus 210, in an embodiment. The information may indicate, for example, either the presence or absence of an undeployed relay device in the host user's physical possession or in a proximity to the mobile device 200.

The at least one battery subsystem 212 may be configured to accept at least one rechargeable or disposable battery, in an embodiment, and accordingly may include a battery housing (not illustrated), which may hold the at least one battery. The at least one battery subsystem 212 may be operatively coupled to any one or more of the at least one wireless network interface 202, the at least one processing subsystem 204, the at least one data storage subsystem 206, the at least one user interface 208, and/or the at least one relay device detection apparatus 210, in an embodiment. Batteries included within the at least one battery subsystem 212 may provide power to the at least one wireless network interface 202, processing subsystem 204, data storage subsystem 206, user interface 208, and relay device detection apparatus 210.

Referring again to FIG. 1, selected ones of links 120-128, 130-132, 140-142, 150-152, and 160 may be two-way radio links, in an embodiment. In another embodiment, any one or more of links 120-128, 130-132, 140-142, 150-152, and 160 may be one-way radio links. Links 120-128, 130-132, 140-142, 150-152, and 160 may be used to transfer information using any of a number of wireless communication protocols. Communications between field devices 104-119 and control center 102 over links 120-128, 130-132, 140-142, 150-152, and 160 may be governed by one or more communication technologies. For example, but not by way of limitation, communications between field devices 104119 and control center 102 may use any of a number of modulation and multiple access technologies. In various embodiments, modulation and multiple access on links 120-128, 130-132, 140-142, 150-152, and 160 may be performed using one or more technologies selected from a group of technologies that includes, but is not limited to, Time Division Multiple Access (TDMA), Frequency Division Multiple Access (FDMA), Code Division Multiple Access (CDMA), Wideband CDMA (WCDMA), Orthogonal FDMA (OFDMA), Interleaved FDMA (IFDMA), Discrete Fourier Transform (DFT) spread OFDMA (DFT OFDMA), Spatial Division Multiple Access (SDMA), or combinations thereof, for example.

Radio signals transmitted over a wireless link (e.g., links 120-128, 130-132, 140-142, 150-152, and 160) may attenuate as they travel away from the originating wireless device. In addition, radio signals may encounter interference from other transmissions (e.g., multi-path fading and echoing). Accordingly, a receiving device may experience good signal quality, moderate signal quality, poor signal quality, or no signal, depending on the amount of attenuation and the interference encountered. Signal quality may be quantified by signal strength and/or other types of signal quality measurements, in various embodiments. For example, but not by way of limitation, signal quality be quantified using any of a number of signal quality measurements, including but not limited to Signal to Noise Ratio (SNR), Signal to Interference plus Noise Ratio (SINR), and/or bit error rate (BER), for example.

Referring still to FIG. 1, coverage areas 170, 171, 172, 173, 174, 175, 176 represent geographical areas within which control center 102 and deployed relay devices 104-109 adequately may provide communication services to mobile devices 110-115 (e.g., signal quality within these areas is good or moderate). Coverage areas 170-176 are modeled using hexagons in the illustrated example. In reality, a coverage area for any given control center or relay device likely would have an irregular circumference which may vary with time due to transmission medium conditions, among other things. Also, a coverage area may have a three-dimensional shape, and a geographical area in which a network is being established may have horizontal and/or vertical dimensions (e.g., in a building or urban area, and/or over mountainous terrain). Furthermore, in some cases, coverage areas associated with different field devices and control centers may overlap. To facilitate explanation, however, substantially horizontal, hexagonal models for coverage areas 170-176 are used.

The cumulative coverage area of the network may be defined as the geographical area spanned by all of the coverage areas 170-176. The farthest range of the network may be defined as the farthest distance from control center 102 that the network may provide services to mobile devices 110-115. For example, in the illustrated example, the farthest range is the distance 180 from control center 102 to the farthest edge of coverage area 173. In some cases, the farthest range may be extended through mobile-to-mobile links, such as link 142. However, for ease of description, these types of range extensions are not discussed in detail herein.

In some situations, it may be desirable to form a network with a vast cumulative coverage area and a farthest range that is a significant distance from the control center. During network setup, each host user may be capable of carrying only a limited number of relay devices. Accordingly, it may be desirable to manage deployment of relay devices so that the host users do not prematurely run out of relay devices before the desired cumulative coverage area or range is achieved. In some situations, two or more host users may independently determine that relay device deployment is warranted in the same area at approximately the same time. In these cases, it may be desirable to avoid deploying multiple relay devices that provide service within substantially overlapping coverage areas. Two or more relay devices that provide service within substantially overlapping coverage areas are referred to herein as “redundant relay devices.”

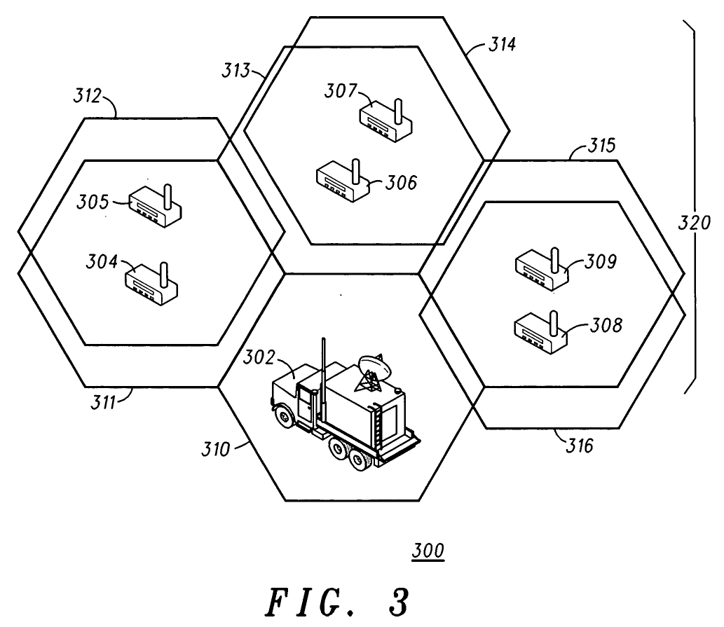

FIG. 3 illustrates a conceptual diagram of an adaptively-augmentable wireless communication system 300, in accordance with another example embodiment. System 300 includes a control center 302, and multiple deployed relay devices 304, 305, 306, 307, 308, 309. System 300 also may include mobile devices (e.g., mobile devices 110-115). However, the mobile devices are not illustrated for simplicity. Although one control center 302 and six relay devices 304-309 are illustrated, system 300 may include more than one control center and/or more or fewer relay devices.

Control center 302 and deployed relay devices 304-309 may provide service within coverage areas 310, 311, 312, 313, 314, 315, 316. The cumulative coverage area of the network may be defined as the geographical area spanned by all of the coverage areas 310-316. The farthest range of the network may be defined as the farthest distance from control center 302 that the network may provide services to mobile devices. For example, in the illustrated example, the farthest range may be the distance 320 from control center 302 to the farthest edge of coverage area 314.

In the illustrated example, several sets of coverage areas may be considered to be substantially overlapping. For example, a first set of coverage areas 311 and 312 may be considered to be substantially overlapping, as may a second set of coverage areas 313 and 314, and a third set of coverage areas 315 and 316. In an embodiment, the term “substantially overlapping coverage areas” may include two or more coverage areas that overlap each other by at least a predetermined percentage (e.g., 25%, 50%, or some other percentage) of the area of the smallest of the coverage areas. In another embodiment, the term “substantially overlapping coverage areas” may include two or more coverage areas that commonly cover at least a predetermined percentage (e.g., 50%, 75%, or some other percentage) of a total number of field devices covered collectively by the coverage areas.

In an embodiment, “redundant relay devices” may be defined as deployed relay devices associated with a set of substantially overlapping coverage areas. For example, a first set of relay devices 304 and 305 may be considered redundant relay devices. A second set of relay devices 306 and 307 also may be considered redundant relay devices, as may a third set of relay devices 308 and 309. In other embodiments, redundant relay devices may be defined as deployed relay devices that are within at most a predetermined fraction (e.g., 25%, 50%, or some other percentage) of an average transmission range of the relay devices

FIG. 1 and FIG. 3 may be compared to demonstrate the effects of redundant relay device deployment on a network's cumulative coverage area and farthest range. The systems 100, 300 of FIG. 1 and FIG. 3 each have one control center (e.g., control centers 102, 302) and an equal number of deployed relay devices (e.g., relay devices 104-109, 304-309). In addition, each of the coverage areas (e.g., coverage areas 170-176, 310-316) is modeled by identically sized hexagons. The cumulative coverage area of the network of FIG. 1 is the geographical area spanned by coverage areas 170-176, and the cumulative coverage area of the network of FIG. 3 is the geographical area spanned by coverage areas 310-316. By comparing the two figures, it is apparent that the cumulative coverage area of FIG. 1 is substantially larger than the cumulative coverage area of FIG. 3. In addition, the farthest range 180 of the network of FIG. 1 is substantially greater than the farthest range 320 of the network of FIG. 3. Accordingly, the example demonstrates that deployment of redundant relay devices (e.g., relay devices 304-305, 306-307, and 308-309) may significantly affect the possible cumulative coverage area of a network, as well as its farthest range.

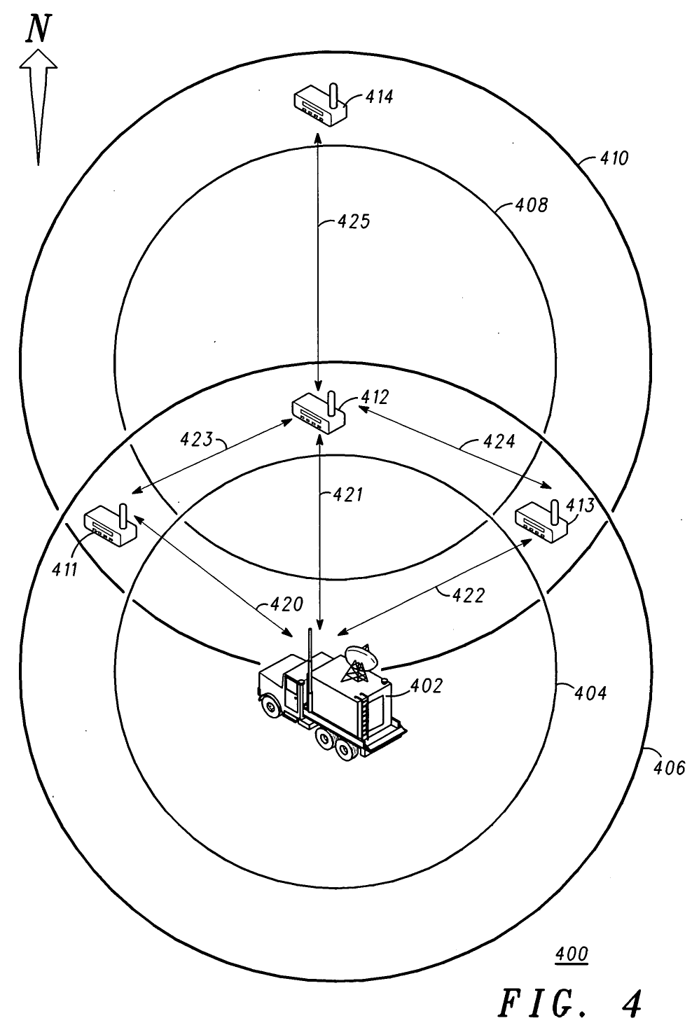

When a host user has run out of undeployed relay devices, he may not be able to assist in expanding the network coverage area. In some cases, another nearby host user may have an undeployed relay device available. Various embodiments of deploying relay devices are described herein, which may automatically enable a first host user's mobile device to initiate a request for another host user to deploy a relay device on the first host user's behalf (e.g., when the first host user has run out of undeployed relay devices and has reached a marginal signal quality area). Various embodiments of deploying relay devices also are described herein, which may reduce a likelihood that host users will deploy redundant relay devices. These embodiments are described in conjunction with FIGS. 4-11.

FIG. 4 illustrates a conceptual diagram-400 of signal quality threshold perimeters, in accordance with an example embodiment. When network setup is initiated, an adaptively-augmentable network may include a single control center, such as control center 402, and zero deployed relay devices. A group of host users may collect in a first area, such as an area proximate to control center 402. As described previously, each host user may carry with him a mobile device (not illustrated) and one or more undeployed relay devices. The host users may then begin to fan out from the control center 402 toward or into a geographic area (e.g., an incident site).

In an embodiment, as the host user travels away from control center 402, the host user's mobile device (e.g., mobile device 110, FIG. 1) may continuously, periodically or a periodically measure the quality of signals received from the control center 402. As mentioned previously, signal quality may be a measurement of SNR, SINR, BER or some other quantifiable measurement. When the quality of the control center signals drops below a predetermined, first threshold (referred to herein as a “deployment threshold”), the mobile device may produce a deployment alert, which alerts the host user that he should deploy a relay device. Deployment threshold perimeter 404 represents a geographical perimeter where the quality of the control center signal drops below a deployment threshold. Although it is modeled to have a circular perimeter, the perimeter may have an irregular shape and/or may vary with time.

In an embodiment, a deployment threshold may be in the same unit of measurement as the signal quality measurement. For example, in an embodiment, a deployment threshold may be a SNR of 1.2:1, although in other embodiments, the deployment threshold may be larger or smaller, or may be quantified in different units. Using the given example, when the measured control center signal has a SNR of 1.5:1, the mobile device may not produce a deployment alert. When the measured control center signal has a SNR of 1.1:1, the mobile device may produce a deployment alert.

When the host user receives a deployment alert, he may deploy a relay device, provided that he has one to deploy. If a host user travels too far beyond the deployment threshold perimeter 404 without deploying a relay device, the quality of control center signals may become so poor that reliable communication with the control center 102 may rot be achieved. Out-of-range threshold perimeter 406 represents a geographical perimeter where the quality of the control center signals has dropped below an out-of-range threshold that indicates poor signal quality with the control center 102. For example, in an embodiment, an out-of-range threshold may be an SNR of about 1.05:1, although in other embodiments, the out-of-range threshold may be larger or smaller, or may be quantified in different units In an embodiment, a host user's mobile device may produce an out-of-range alert to indicate that the host user has traveled beyond an out-of-range perimeter 406. The host user may then retreat, if he so desires.

A relay device may be considered to be deployed when it has established communications with the network. Once established, a relay device may serve as a node within a radio communication route between one or more mobile devices, and/or other deployed relay devices, and/or a control center. In an embodiment, a route control method may be implemented in the system to provide network connectivity. Route redundancy may be provided within all or portions of the network, so that when a relay device is disestablished (e.g., the relay device fails, powers down, or is cut off from the network for another reason), one or more other relay devices may be available to continue to provide communications through the network.

Adequate network communication quality may be achieved, in most circumstances, when host users deploy relay devices at or beyond a deployment threshold perimeter 404, but within an out-of-range threshold perimeter 406. Relay devices 411, 412, 413 represent relay devices that have been deployed by up to three host users between the deployment threshold perimeter 404 and the out-of-range threshold perimeter 406. Once deployed, relay devices 411-413 may begin communicating with control center 402 over control to-relay links 420, 421, 422, and may communicate among themselves over relay-to-relay links 423, 424.

At least one host user may continue to move in a direction (e.g., due north) away from control center 402 and deployed relay devices 411-413. In an embodiment, a host user's mobile device may be capable of receiving signals from at least one, and possibly all, of relay devices 411-413. The host user's mobile device may continuously, periodically or a periodically measure the quality of signals received from relay devices 411-413. In an embodiment, when the host user reaches a deployment threshold perimeter 408 of a relay device having the highest quality signal (e.g., relay device 412), the mobile device again may produce a deployment alert. In response to the alert, the host user may deploy another relay device, such as relay device 414, provided that one is available. Desirably, the host user will deploy the relay device at or beyond the deployment threshold perimeter 408, but within an out-of-range threshold perimeter 410 for relay device 412. Once deployed, relay device 414 may begin communicating with other relay devices (e.g., relay device 412) over relay-to-relay links (e.g., link 425).

Recognition by a mobile device that it has encountered a deployment threshold perimeter (e.g., perimeter 404 or 408) may be considered a “deployment event.” Other events also may be considered deployment events, in various embodiments. For example, but not by way of limitation, a “deployment event” may include an event selected from a group of events that includes: a) a determination that a mobile device has reached a deployment threshold perimeter; b) a determination that the mobile device has reached a particular geographical location; c) a determination that the mobile device has reached a certain distance from a control center or a previously deployed relay device; and d) a receipt of a message from another field device, control center, or other communication apparatus requesting deployment of a relay unit, in various embodiments.

FIG. 5 illustrates a flowchart of a method for recognizing and responding to a deployment event, in accordance with an example embodiment In an embodiment, the method processes may be carried out substantially by a device associated with a host user, such as a mobile device (e.g., devices 110-115, FIG. 1), for example. In other embodiments, some or all of the method processes may be carried out by other apparatus (e.g., relay devices and/or other apparatus).

In block 502, the device may measure the signal qualities of its field device neighbors (e.g., deployed relay devices 104-109, FIG. 1, and mobile devices 110-115). A “field device neighbor” may mean, in various embodiments, any one or more field devices (e.g., relay devices, other mobile devices, and/or a control center) whose signals may be received by the mobile device. In various embodiments, the mobile device may measure and quantify signal quality in terms of SNR, SINR, BER or some other measurement In an embodiment, the mobile device maintains a table (e.g., FIG. 6) that identifies some or all field device neighbors. The table may further indicate the signal qualities of the signals from the field device neighbors, in an embodiment.

FIG. 6 illustrates a field device neighbor table 600, in accordance with an example embodiment. In an embodiment, field device neighbor table 600 includes N records 601, 602, 603, 604, 605, 606 where N may be the number of field device neighbors, and N may range from zero to a maximum value (e.g., 100, although other values could be used). In an embodiment, each record 601-606 may include a record number field 610, a neighbor identifier (ID) field 612, and a signal quality indicator field 614. Record number field 610 may indicate a record number (e.g., an integer or other value) for a particular record.

Neighbor ID field 612 may indicate a device ID (e.g., a hexadecimal Cr other value) for a field device neighbor. In an embodiment, a device ID value may indicate the type of field device. One or more bits of the device ID may be used to indicate that the device is one of a control center, a relay device or a mobile device. For example, control center may be indicated, for example, with a “0” in the leftmost hexadecimal digit (e.g., record 602 with a device ID of 0021A), a relay device may be indicated with a “ I ” in the leftmost hexadecimal digit (e.g., records 601 and 604 with device IDs of 1F 3D 2 and 1017C), and a mobile device may be indicated with a “2” in the leftmost hexadecimal digit (e.g., records 603, 605, and 606 with device IDs of 20D 22, 26FFA, and 2B 19C). In other embodiments, other bits may be used to indicate device type, and/or the device type may be determined by a mobile device in another manner (e.g., by evaluation of one or more messages received from the device).

Signal quality indicator field 614 may include a value that indicates the signal quality of signals received from the field device neighbors. A “signal quality indicator” may include, for example, an integer or floating point representation of a signal quality measurement, a value that indicates that a signal quality measurement falls within a range, a value that indicates that a signal quality measurement is higher or lower than a threshold, and/or a value that encodes, classifies or categorizes a signal quality measurement. In an example embodiment, a signal quality measurement may be classified as good (e.g., value of 1), marginal (e.g., value of 2) or poor (e.g., value of 3). Classification may be determined, for example, based on whether the signal quality is above, equal to, or below a signal quality threshold. For example, if a signal quality is above a deployment threshold, the quality may be classified as good. If a signal quality is between a deployment threshold and an out-of-range threshold, the quality may be classified as marginal, and if a signal quality is below an out-of-range threshold, the quality may be classified as poor. In another example embodiment, each signal quality indicator may include a value (e.g., an integer) that is derived from a predetermined monotonic mapping from a corresponding signal quality measure, such as SNR, SINR, or BER, for example. When a signal of a device in the field device neighbor table becomes too low or undetectable, the associated record may be deleted from the table, in an embodiment. The above classifications are for example purposes only. In other embodiments, other ways of indicating signal quality could be used.

Referring again to FIG. 5, in block 504, the mobile device may evaluate the signal qualities of neighbor relay devices (if any) (e.g., the devices associated with records 601 and 604, FIG. 6) and neighboring control centers (if any) (e.g., the control center associated with record 602), to determine whether at least one neighbor relay device or a control center has a signal quality that is considered adequate for reliable communications (e.g., a quality of 1, as is indicated in record 604). A neighbor relay device or control center signal quality may be considered adequate, for example, when the corresponding signal quality indicator indicates that the signal quality is above a signal quality threshold. In alternate embodiments, a signal quality may be considered adequate when a signal quality is equal to a deployment threshold, or whether a signal quality is equal to or above a deployment threshold. In other alternate embodiments, a signal quality may be considered inadequate when the signal qualities are below a deployment threshold, or equal to or below a deployment threshold.

When no neighbor relay device or control center signal quality is considered adequate for reliable communications, the mobile device may initiate a “self-triggered deployment.” A “self-triggered deployment” may be a relay device deployment that is performed by the host user in response to his mobile device's determination that no relay device signal, other mobile device signal, or control center signal is receivable by the mobile device that has a signal quality that is considered adequate to provide reliable communications with the network (e.g., the mobile device may be unable to maintain reliable communications with a control center without a relay device being deployed that may have a signal quality that may be considered adequate).

In block 505, a determination may be made whether a self-triggered deployment has been initiated. When a determination is made that no self-triggered deployment has been initiated, the method may iterate as shown, in an embodiment. When a determination is made that a self-triggered deployment has been initiated, a determination may be made, in block 506, whether the host user has an undeployed relay device available to deploy. As discussed previously, a host user may have a harness or other apparatus to which undeployed relay devices are attached, and the harness or the undeployed relay devices may be capable of conveying information to a mobile device, indicating the presence of an undeployed relay device in proximity to the mobile device.

When a determination is made that the host user has no relay device available to deploy, the mobile device may initiate a request-triggered deployment, in block 508. A “request-triggered deployment” may be a relay device deployment that is performed by another host user in response to his mobile device's receipt of a deployment request from a requesting mobile device. In an embodiment, a mobile device may initiate a request-triggered deployment by transmitting a deployment request (DEP_REQ) message over the air interface. In an embodiment, the DEP_REQ message is to invoke a second mobile device to determine whether the second mobile device should alert a second host user associated with the second mobile device to deploy an undeployed relay device associated with the second host user. In other words, a DEP_REQ message may indicate, to other mobile devices within communication rant of the mobile device, that the host user has no available undeployed relay devices, and that the mobile device is requesting that another host user deploy a relay device on his behalf, if one is available.

FIG. 7 illustrates DEP_REQ message format 700, in accordance with an example embodiment. In an embodiment, a DEP_REQ message indicates that a first device is requesting deployment of an undeployed relay device by a host user associated with another device. In an embodiment, control centers (e.g., control center 102, FIG. 1), relay devices (e.g., relay devices 104-109), and mobile devices (e.g., mobile devices 110-115) transfer control messages and data messages between each other in the form of packets. A message may include one or more packets. Accordingly, DEP_REQ message 700 may include multiple fields, including a header field 702, a requesting mobile device ID field 704, a number of mobile device neighbors field 706, and a request sequence number (no.) field 708, in an embodiment. Header field 702 may include information that identifies the message as a DEP_REQ message. Requesting mobile device ID field 704 may include the device ID of the mobile device that transmitted the DEP_REQ message 700. Number of mobile device neighbors field 708 may include an indicator of how many candidate mobile devices the requesting mobile device has. The number of mobile device neighbors field 706 may indicate, for the requesting device, how many mobile device neighbors have signal qualities above a deployment or other threshold, in an embodiment. For example, referring again to FIG. 6, a requesting mobile device may indicate, in number of mobile device neighbors field 706, that it has three mobile device neighbors (e.g., the devices associated with records 603, 605, and 606, FIG. 6). Request sequence number field 708 may include a sequence number for the request, to indicate whether it is a first request or a subsequent request, in an embodiment. As will be described in more detail later, a mobile device neighbor of the requesting mobile device may be considered to be a candidate mobile device when it may potentially be responsive to a requesting mobile device's DEP_REQ message, in an embodiment.

Referring again to FIG. 5, a mobile device may wait a period of time, referred to as a request waiting period, to see whether the mobile device has received a responsive deployment announcement (DEP_ANN) message from another mobile device. A responsive DEP_ANN message may indicate that one of the mobile device's neighbors has deployed a relay device, in response to receiving the DEP_REQ message transmitted in block 508. A request waiting timer may be started, in block 509, in order to time the request waiting period.

FIG. 8 illustrates a DEP_ANN message format 800, in accordance with an example embodiment. In an embodiment, a DEP_ANN message indicates that an announcing mobile device is initiating the deployment of an undeployed relay device. DEP_ANN message 800 may include multiple fields, including a header field 802, an announcing mobile device ID field 804, and a requesting mobile device ID field 806, in an embodiment. Header field 802 may include information that identifies the message as a DEP_ANN message. Announcing mobile device ID field 804 may include the device ID of the mobile device that transmitted the DEP_ANN message 800. Requesting mobile device ID field 806 may include the device ID of a mobile device that transmitted a DEP_REQ message (e.g., message 700, FIG. 7), to which the announcing mobile device may be responding. When the announcing mobile device did not deploy the relay device in response to a DEP_REQ message, but instead deployed the relay device based on its own detection that relay device deployment is warranted(e.g., a self-triggered deployment), the requesting mobile device ID field 806 may include the announcing mobile device ID, or may have a zero or other predetermined exclusive value, indicating that the message is not in response to a DEP_REQ message.

Referring again to FIG. 5, in block 510, a determination may be made whether the mobile device has received a responsive DEP_ANN message from another mobile device, in an embodiment. When a determination is made that the mobile device has received a responsive DEP_ANN message, the method may proceed to block 511 to repeat (e.g., retransmit) the received DEP_ANN message. In an embodiment, when one or more of the other mobile device neighbors may be hidden from the announcing mobile device (e.g., they may not receive the DEP_ANN message directly from the announcing mobile device), this may help to ensure that the other mobile device neighbors receive the DEP_ANN message. After repeating the DEP_ANN message, the method may return to block 502 and iterate as shown. When a determination is made that the mobile device has not received a responsive DEP_ANN message, a determination may be made whether the request waiting timer has expired, in block 512. A request waiting period may be a predetermined period of time (e.g., 5 seconds, 10 seconds, or some other period of time) that the mobile device may wait before it attempts to retransmit a DEP_REQ message. When a determination is made that the request waiting timer has not expired, the method may iterate as shown. When a determination is made that the request waiting timer has expired, the mobile device may return to block 508 and transmit another DEP_REQ message. In an embodiment, the request sequence number (e.g., in request sequence no. field 708, FIG. 7) may have an incremented value. In this way, the mobile device may repeatedly request from neighbor mobile devices that they deploy a relay device on his behalf, until such deployment may occur. In another embodiment, when a determination is made that no DEP_ANN message has been received, the mobile device eventually (e.g., after a predetermined number of DEP_REQ messages have been transmitted) may alert the host user. The host user may then retreat, if he so desires.

Referring again to block 506, when a determination is made that the host user has a relay device available to deploy, the mobile device may transmit a DEP_ANN message (e.g., message 800, FIG. 8), in block 514, in an embodiment. The mobile device also may produce a deployment alert, in block 516. The deployment alert may be an audible and/or vibratory alert, for example, which indicates to the host user that he should deploy one of his undeployed relay devices.

Once a host user hears or feels a deployment alert, it may take the host user a period of time in which to deploy a relay device, and for the relay device to establish communications with the network. During this time, the host user's mobile device may receive one or more DEP_REQ messages from one or more other mobile devices. In an embodiment, the mobile device may disregard DEP_REQ messages from other mobile devices for a period of time, referred to as a deployment blackout time. This may provide the advantage of reducing a likelihood of deploying redundant relay devices, under various circumstances. In an embodiment, a blackout timer is started, in block 517, in order to time the blackout time.

In block 518, a determination may be made whether a deployment blackout time has expired, in an embodiment. A deployment blackout time may be a predetermined period of time (e.g., 5 seconds, 10 seconds or some other period of time), which may be measured from the time that the mobile device transmitted a DEP_ANN message (e.g., block 514) or the time that the mobile device alerted the host user to deploy a device (e.g., block 516). When a determination is made that the deployment blackout time has not expired, in block 518, the mobile device may disregard any DEP_REQ messages that the mobile device may receive from other mobile devices, in block 520. The method may iterate as shown.

When a determination is made that the deployment blackout time has expired, in block 518, the method may return to block 502, and repeat. In another embodiment, rather than waiting a deployment blackout time, the method may return to block 502 after the mobile device has determined that a relay device has been deployed based on signal strength measurements, for example. In another embodiment, a newly-deployed relay device may transmit a message to the mobile device, indicating its successful deployment.

Assuming that a host user has successfully deployed a relay device, the mobile device should receive signals from the newly-deployed relay device, a new table entry may be added to the field device neighbor table (e.g., table 600 FIG. 6), and the signal quality of signals from the newly-deployed relay device may be indicated in the field device neighbor table. In the illustrated embodiment, the processes of recognizing and responding to a deployment event may continuously repeat. In other embodiments, the process may end after receiving a responsive DEP_ANN from another mobile device (e.g., block 510) or after a deployment blackout time has expired (e.g., block 518), and the process may later be re-initiated and executed, for example, in response to a periodic interrupt or some other event.

As discussed in conjunction with blocks 508-512 of FIG. 5, when a host user does not have a relay device to deploy, his mobile device may transmit a DEP_REQ message (e.g., message 700, FIG. 7). A DEP_REQ message may be received by multiple mobile device neighbors. In various embodiments, a mobile device neighbor that receives a DEP_REQ message performs a process of determining whether or not to alert its host user to deploy a relay device, as will be described in detail in conjunction with FIGS. 9-11.

FIG. 9 illustrates a flowchart of a method for receiving and responding to a DEP_REQ message (e.g., message 700, FIG. 7), in accordance with an example embodiment In an embodiment, the method processes may be carried out substantially by a device associated with a host user, such as a mobile device (e.g., devices 110-115, FIG. 1), for example. In other embodiments, some or all of the method processes may be carried out by other apparatus (e.g., relay devices and/or other apparatus). In an embodiment, the method of FIG. 9 includes making a deployment decision to initiate a deployment of an undeployed relay device associated with the host user, in response to receiving a DEP_REQ message from an air interface.

In block 902, a device may receive a DEP REQ message (e.g., message 700, FIG. 7) from another mobile device. A DEP_REQ message may have been transmitted by another mobile device, for example, when the other mobile device initiated a request-triggered deployment. As discussed previously in conjunction with FIG. 5, the other mobile device may have initiated a request-triggered deployment upon determining that its received relay device signals were not considered adequate for reliable communications (e.g., blocks 504, 505, FIG. 5), and that its host user had no undeployed relay devices to deploy (e.g., block 506, FIG. 5). Referring to FIG. 9, upon receipt of a DEP REQ message, a determination may be made, in block 904, whether the host user has an undeployed relay device available to deploy. When a determination is made that no relay device is available to deploy,the DEP_REQ message may be disregarded, in block 906, and the method may end.

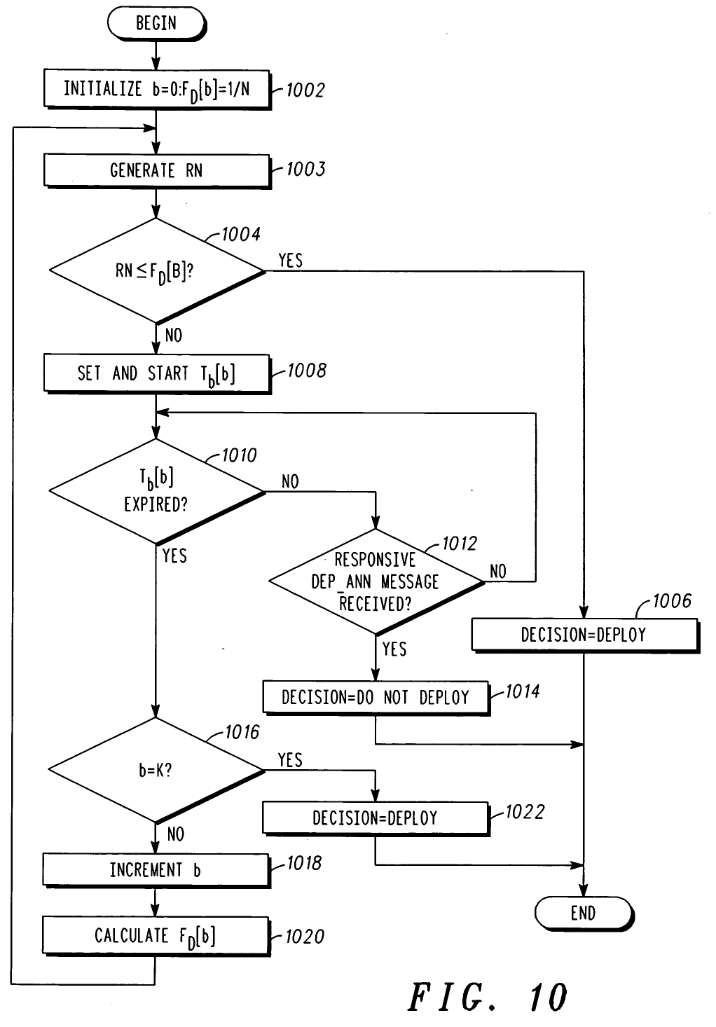

When a determination is made that a relay device is available to depby, a deployment decision may be made in block 908. In an embodiment, a device makes a deployment decision based, at least in part, on how many candidate mobile devices the requesting mobile device has identified (e.g., in a number of mobile device neighbors field 706 of a DEP_REQ message 700, FIG. 7). An example embodiment of a deployment decision-making process is illustrated in FIG. 10 and described later. In another embodiment, a device may make a decision to deploy a relay device based simply on the fact that its host user has at least a predetermined number (e.g., one, two, or some other number) of undeployed relay devices in his possession. In other embodiments, a deployment decision may be based on some other criteria. In an embodiment, block 908 may produce a “deploy” or “do not deploy” decision indicator.

A determination may be made, in block 910, whether the deployment decision is to deploy a relay device. When the deployment decision is not to deploy a relay device, the DEP_REQ message may be disregarded, in block 906, and the method may end. When the deployment decision is to deploy a relay device, the mobile device may transmit a responsive DEP_ANN message (e.g., message 800, FIG. 8) in block 912, in an embodiment. The mobile device also may produce a deployment alert, in block 914. The deployment alert may be an audible and/or vibratory alert, for example, which indicates to the host user that he should deploy one of his undeployed relay devices.

In an embodiment, the mobile device may disregard DEP_REQ messages from other mobile devices for a period of time, referred to as a deployment blackout time. A deployment blackout timer may be started, in block 915, in order to time the deployment blackout time. In block 916, a determination may be made whether the deployment blackout time has expired, in an embodiment. When a determination is made that the deployment blackout time has not expired, the mobile device may disregard any new DEP_REQ messages that the mobile device may receive from other mobile devices, in block 918. The method may iterate as shown. When a determination is made that the deployment blackout time has expired, in block 916, the method may end. In another embodiment, rather than waiting a deployment blackout time, the method may end after the mobile device has determined that a relay device has been deployed based on signal strength measurements, for example. In another embodiment, a newly-deployed relay device may transmit a message to the mobile device, indicating its successful deployment.

As mentioned above in conjunction with block 908, a mobile device that has received a DEP_REQ message from another mobile device may make a deployment decision which involves the mobile device deciding whether or not to initiate relay device deployment by alerting its host user to deploy a relay device. Because multiple mobile devices may receive a DEP_REQ transmitted by a requesting mobile device, it is possible that multiple mobile devices may decide to initiate relay device deployment. This may result in the deployment of redundant relay devices, in some cases.

In order to reduce a likelihood that more than one of the host users (e.g., those associated with the candidate mobile devices of the requesting mobile device)deploy a relay device in response to the same DEP_REQ message, a candidate mobile device may make a deployment decision based, at least in part, on information regarding the number of candidate mobile devices identified by the requesting mobile device, in an embodiment. In a particular embodiment, in response to a received DEP_REQ message, a first candidate mobile device may decide whether or not to initiate relay device deployment based on how likely it is that at least a second candidate mobile device may decide to initiate relay device deployment in response to the same DEP_REQ message. When a likelihood is relatively high that a second candidate mobile device may decide to initiate relay device deployment, the first candidate mobile device may decide not to initiate relay device deployment For example, a likelihood may be relatively high when a number of candidate mobile devices is relatively large (e.g., three or more). When a likelihood is relatively low that a second candidate mobile device may decide to initiate relay device deployment, the first candidate mobile device may decide to initiate relay device deployment. For example, a likelihood may be relatively low when a number of candidate mobile devices is relatively small (e.g., one or two).

Embodiments of the inventive subject matter provide for probabilistic deferment of relay device deployment to statistically control an expected total number of relay devices deployed by multiple host users in response to a deployment request. In an embodiment, a candidate mobile device may employ a probabilistic algorithm to determine whether to initiate relay device deployment, provided that there is an undeployed relay device available. In a particular embodiment, a first candidate mobile device that has received a DEP_REQ message may calculate a probability parameter and a random number, which the first candidate mobile device may compare to decide whether to initiate relay device deployment. Based on this initial probability parameter, the first candidate mobile device may determine whether to initiate relay device deployment.

When the first candidate mobile device decides not to initiate relay device deployment, the first candidate mobile device may wait a period of time, referred to as a backoff period, to see whether another candidate mobile device initiates relay device deployment When no other candidate mobile device has initiated relay device deployment before the end of the backoff period, the first candidate mobile device may recalculate the probability parameter and the random number, and the method may iterate. As the probability parameter and random number may change, eventually the first candidate mobile device may decide to initiate relay device deployment. This embodiment is described below.

FIG. 10 illustrates a flowchart of a method for making a deployment decision (e.g., block 908, FIG. 9), in accordance with an example embodiment. In an embodiment, the method processes may be carried out substantially by a device associated with a host user, such as a mobile device (a “candidate mobile device”) (e.g., devices 110-115, FIG. 1) that has received a DEP_REQ message (e.g., message 700, FIG. 7) from another mobile device (a “requesting mobile device”). In other embodiments, some or all of the method processes may be carried out by other apparatus (e.g., relay devices and/or other apparatus). The method may begin after a candidate mobile device has received a DEP_REQ message from a requesting mobile device (e.g., block 902, FIG. 9), and the candidate mobile device has determined that its host user may have an undeployed relay device available to deploy (e.g., block 904)

Referring now to FIG. 10, in block 1002, the candidate mobile device may initialize a backoff period counter, b, and a probability parameter, F_{D}[b]. The backoff period counter, b, may indicate a number of times that the candidate mobile device has waited through a backoff period. In an embodiment, the backoff period counter, b, may be initialized to a value of 0, although it may be initialized to other values, in other embodiments. As will be described later, the number of backoff periods that a candidate mobile device may wait may be limited to a predetermined maximum number of backoff periods, K.

The candidate mobile device may initialize a probability parameter, F_{D}[b], to a value related to the number of candidate mobile devices identified by the requesting mobile device, or to the number of devices that may be available to respond to the DEP_REQ message. As discussed previously in conjunction with FIG. 7, the number of candidate mobile devices may be identified in a number of mobile device neighbors field (e.g., field 706, FIG. 7) of a DEP_REQ message. In an embodiment, the probability parameter, F_{D}[b], may be initialized to 1/N, where N is a number of candidate mobile devices identified by the requesting mobile device. Accordingly, for example, when a DEP REQ message indicates that the requesting mobile device has three candidate mobile devices, the probability parameter may be initialized to ⅓. This value may indicate a probability that the candidate mobile device may consider in deciding whether to initiate relay device deployment in response to the DEP_REQ message.

In block 1003, the candidate mobile device may generate a uniformly random number (RN). In an embodiment, RN may be a uniformly random number between the values of 0 and 1, inclusive. In other embodiments, RN may be non-uniformly random and/or may be generated between two values other than 0 and 1, inclusive.

In block 1004, a determination may be made whether RN is less than or equal to the probability parameter, F_{D}[b]. When a determination is made that RN is less than or equal to F_{D}[b], the candidate mobile device may indicate a decision to initiate relay device deployment, in block 1006, and the method may end (e.g., the process may return a deployment decision of “yes”, in block 908, FIG. 9).

When a determination is made, in block 1004, that RN is greater than the probability parameter, F_{D}[b], a backoff period timer, T_{b}[b], may be set and started, in block 1008, in an embodiment. The backoff period timer may represent an interval of time that the mobile device may wait for another mobile device to initiate relay device deployment In an embodiment, the backoff period timer may be set to a value that changes based on how many backoff periods the mobile device has waited For example, during a first backoff period (e.g., b=0), the backoff period timer may be set to a first value (e.g., 8 seconds), and during subsequent backoff periods (e.g., b=1, 2, 3), the backoff period timer may be set to different values (e.g., 4 or 2 seconds). In an embodiment, the candidate mobile device determines the initial value of the backoff period timer, T_{b}[b], from information stored within a backoff period table. In an alternate embodiment, the backoff period timer may be initialized to a same initial value during each backoff period.

FIG. 11 illustrates a backoff period table 1100, in accordance with an example embodiment. Backoff period table 1100 may include multiple entries 1102, 1103, 1104, 1105. Each entry may include a backoff period counter (b) field 1110 and a backoff period timer (T_{b}[b]) initial value field 1112, in an embodiment. For each backoff period (b=0, 1, . . . K−1) identified in the backoff period counter field 1110, a backoff period timer initial value may be specified in the backoff period timer initial value field 1112. Accordingly, for example, during a first backoff period (b=0), a backoff period timer initial value may be 8 seconds (see entry 1102). During a last backoff period (b=K−1), a backoff period timer initial value may be 2 seconds (see entry 1105). The values indicated in FIG. 11 are for example purposes only. Other values may be used, in other embodiments. Further, although the backoff period timer initial values are shown to be decreasing as the backoff period counter increases, in other embodiments, some or all of the backoff period timer initial values may increase and/or may be equal.

Referring again to FIG. 10, a determination may be made, in block 1010, whether the backoff period timer has expired. When a determination is made, in block 1010, that the backoff period timer has not expired, a determination may be made, in block 1012, whether a responsive DEP_ANN message (e.g., message 800, FIG. 8) has been received. A responsive DEP_ANN message may indicate that another candidate mobile device has initiated relay device deployment in response to the requesting mobile device's DEP_REQ message.

As mentioned previously, a DEP_ANN message may include a requesting mobile device ID field (e.g., field 806, FIG. 8). When a candidate mobile device evaluates a received DEP_ANN message, and determines that the mobile device IDs in the announcing mobile device ID field (e.g., field 804) and the requesting mobile device ID field (e.g., field 806) are different, and further that the mobile device identified in the requesting mobile device ID field (e.g., field 806) corresponds to the mobile device which originally sent the DEP_REQ message (e.g., the requesting mobile device), then the candidate mobile device may determine that a responsive DEP_ANN message has been received.

When a determination is made, in block 1012, that a responsive DEP_ANN message has been received (e.g., another candidate mobile device has initiated relay device deployment in response to the DEP_REQ message), a decision may be made not to initiate relay device deployment, in block 1014, and the method may end (e.g., the process may return a deployment decision of “no”, in block 908, FIG. 9). When a determination is made, in block 1012, that no responsive DEP_ANN message has been received, the method may iterate as shown until the backoff period timer, T_{b}[b], has expired (block 1010) or a responsive DEP_ANN message has been received (block 1012).

Referring again to block 1010, when a determination is made that the backoff period timer, T_{b}[b], has expired, a determination may be made whether the backoff period counter, b, has reached a predetermined maximum number of backoff periods, K. In an embodiment, K may be an integer value between 0 and 10, although in other embodiments, K may have a larger value. When the backoff period counter has reached the maximum number of iterations (e.g., when b=K), a decision may be made to initiate relay device deployment, in block 1022, and the method may end (e.g., the process may return a deployment decision of “yes”, in block 908, FIG. 9). When the backoff period counter has not reached the maximum number of iterations (e.g., when b<K), the backoff period counter, b, may be incremented, in block 1018. In an embodiment, the backoff period counter is incremented by one.

In an embodiment, the probability parameter, F_{D}[b], may again be calculated, in block 1020. As discussed previously, in an embodiment, the probability parameter may change from one backoff period to another. In a particular embodiment, the probability parameter is calculated so that the value increases during each subsequent backoff period. For example, the probability parameter, F_{D}[b], may be calculated according to Eqn. 1:

F_{D}[b]=min{R(t)2^{b}/R₀N, 1}, for b=0, 1, 2, . . . K Eqn. 1

where R(t) denotes a current number of undeployed relay devices carried by the host user, R₀ denotes an initial number of undeployed relay devices carried by the host user, b denotes the backoff period counter value, and N denotes the number of candidate mobile devices identified by the requesting mobile device. In the example embodiment, the probability parameter of F_{D}[b] is dependent upon the current number of undeployed relay devices carried by the host user, R(t), the initial number of undeployed relay devices carried by the host user, R₀ , the backoff period counter value, b, and the number of candidate mobile devices identified by the requesting mobile device, N. In other embodiments, the probability parameter of F_{D}[b] may depend on one or more additional and/or different values, and/or the value of F_{D}[b] may depend on some but not all of R(t), R₀ , b, and N. Also, in other embodiments, a different equation may be employed to determine the probability parameter, F_{D}[b]. Upon calculating the probability parameter, F_{D}[b], in block 1020, the method may return to block 1003 in order to regenerate RN, and the method may iterate as shown. In an alternate embodiment, RN may not be regenerated, and the method may return to block 1004 after block 1020.

The sequence of process blocks illustrated in FIGS. 5, 9, and 10 are for example purposes, and are not to limit the scope of the inventive matter only to those process sequences. Instead, it is to be understood that, in alternate embodiments, some or all of the proceed blocks illustrated in FIGS. 5, 9, and 10 may be performed in different orders, may be performed in parallel, may be combined together, may be expanded into multiple sub-processes, and/or may include one or more intermediate processes that are not illustrated. In addition, some of the process blocks may be optionally performed, in various embodiments.

Thus, various embodiments of relay device deployment methods and apparatus have been described. Embodiments of the inventive subject matter may provide at least one of the following advantageous results: 1) a reduced likelihood of multiple host users deploying redundant relay devices; 2) a reduced likelihood that a host user may prematurely run out of relay devices that he may deploy; 3) a reduced likelihood that a mobile device may become isolated from a network; 4) a potential size increase of a cumulative coverage area of an adaptively-augmentable wireless communication network; and/or 5) a potential range increase of an adaptively-augmentable wireless communication network

While the principles of the inventive subject matter have been described above in connection with specific systems, apparatus, and methods, it is to be clearly understood that this description is made only by way of example and not as a limitation on the scope of the inventive subject matter. For example, although embodiments employed in the context of an adaptively-augmentable radio network have been described, it is to be understood that embodiments may be applied to other types of wireless networks, and functions performed in mobile devices or relay devices may be performed in other types of system nodes or equipment. Further, the phraseology or terminology employed herein is for the purpose of description and not of limitation.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter, it being understood that various changes may be made in the function and arrangement of elements described in an exemplary embodiment without departing from the scope of the inventive subject matter as set forth in the appended claims and their legal equivalents.

The foregoing description of specific embodiments reveals the general nature of the inventive subject matter sufficiently that others can, by applying current knowledge, readily modify and/or adapt it for various applications without departing from the general concept. Therefore, such adaptations and modifications are within the meaning and range of equivalents of the disclosed embodiments. The inventive subject matter embraces all such alternatives, modifications, equivalents, and variations as fall within the spirit and broad scope of the appended claims and their legal equivalents.

What is claimed is:

1. A method performed by a first device associated with a first host user, the method comprising:
making a deployment decision to initiate a deployment of an undeployed relay device associated with the first host user, in response to receiving a first message from an air interface, wherein the first message indicates that a second device is requesting deployment of the undeployed relay device.

2. The method of claim 1, wherein the undeployed relay device is a relay device in a finite set of relay devices available within an adaptively augmentable wireless communication network, and wherein the first message is a message in a set of messages that provides for collaborative deployment of the finite set of relay devices between multiple host users.

3. The method of claim 1, further comprising:
receiving the first message as a deployment request message, wherein the deployment request message includes a device identifier of the second device and information regarding a number of candidate mobile devices identified by the second device.

4. The method of claim 1, further comprising:
determining whether the undeployed relay device is available to the first host user.

5. The method of claim 1, wherein making the deployment decision comprises:
making the deployment decision to initiate the deployment of the undeployed relay device based on information regarding a number of candidate mobile devices identified by the second device.

6. The method of claim 5, wherein making the deployment decision comprises:
calculating a probability parameter,
generating a random number;
comparing the probability parameter to the random number; and
when the random number is less than the probability parameter, making the deployment decision to initiate the deployment of the undeployed relay device.

7. The method of claim 6, wherein calculating the probability parameter comprises:
calculating the probability parameter as 1/N, where N denotes the number of candidate mobile devices identified by the second device.

8. The method of claim 6, wherein calculating the probability parameter comprises:
calculating the probability parameter as
F_{D}[b]=min {R(t)2^{b}/R₀N, 1}
where R(t) denotes a current number of undeployed relay devices carried by the first host user, R₀ denotes an initial number of undeployed relay devices carried by the first host user, b denotes a backoff period counter value, and N denotes the number of mobile device neighbors identified by the second device.

9. The method of claim 5, wherein making the deployment decision comprises:
calculating a probability parameter,
generating a random number,
comparing the probability parameter to the random number; and
when the random number is greater than the probability parameter, waiting a backoff period for another device to deploy a relay device.

10. The method of claim 9, further comprising:
repeating calculating, generating, comparing, and waiting until either a relay device has been deployed or until repeating has occurred a predetermined maximum number of backoff periods.

11. The method of claim 1, further comprising:
transmitting a second message over the air interface, wherein the second message indicates that the first device is initiating the deployment of the undeployed relay device.

12. The method of claim 11, wherein transmitting the second message comprises:
transmitting the second message as a deployment announcement message, wherein the deployment announcement message includes an identifier of the first device and an identifier of the second device.

13. A method performed by a first device associated with a first host user, the method comprising:
transmitting a first message over an air interface, wherein the first message is to invoke a second device to determine whether the second device should alert a second host user associated with the second device to deploy an undeployed relay device associated with the second host user.

14. The method of claim 13, wherein transmitting the first message comprises:
transmitting the first message as a deployment request message, wherein the deployment request message includes a device identifier of the first device and information regarding a number of candidate mobile devices identified by the first device.

15. The method of claim 13, further comprising:
determining that no relay device signal is receivable by the first device that has a signal quality that is considered adequate to provide reliable communications with a wireless network; and
determining that no undeployed relay device is available to the first host user.

16. The method of claim 13, further comprising:
receiving a second message over the air interface, wherein the second message indicates that the second device is initiating a deployment of the undeployed relay device in response to the first message.

17. The method of claim 16, wherein receiving the second message comprises:
receiving the second message as a deployment announcement message, wherein the deployment announcement message includes an identifier of the first device and an identifier of the second device.

18. An apparatus comprising:
a wireless network interface configured to receive a message from an air interface, wherein the message can indicate a request for a deployment of an undeployed relay device; and
at least one processing subsystem, operatively coupled to the wireless network interface, and configured to make a deployment decision, in response to receiving the message, to initiate the deployment of the undeployed relay device.

19. The apparatus of claim 18, further comprising:
a relay device detection apparatus, operatively coupled to the at least one processing subsystem, and configured to detect a presence of the undeployed relay device in a proximity to the apparatus.

20. The apparatus of claim 18, further comprising:
a battery subsystem, operatively coupled to the at least one processing subsystem, and configured to accept at least one battery.
